(19) United States
(12) Patent Application Publication
(10) Pub. No.: US 2014/0152255 A1
(43) Pub. Date: Jun. 5, 2014

(54) Method and Apparatus for Preventing Simultaneous Charging and Fueling of a Plug-In Hybrid Electric Vehicle

(71) Applicant: FORD GLOBAL TECHNOLOGIES, LLC, Dearborn, MI (US)

(72) Inventors: Karin Lovett, Novi, MI (US); Hilde Anne Heremans, Dearborn, MI (US)

(73) Assignee: Ford Global Technologies, LLC, Dearborn, MI (US)

(21) Appl. No.: 13/705,264

(22) Filed: Dec. 5, 2012

(51) Int. Cl. H02J 7/00

(52) U.S. Cl. CPC H02J 7/0029
USPC 320/109; 320/137

(57) ABSTRACT

Simultaneous fuelling and electrical charging of a plug-in electric hybrid vehicle (PHEV) is inhibited by detecting pre-charging electrical continuity between an on-board charger of the vehicle and a charging plug engaging the charger, and impeding opening of a door controlling access to a fueling port if the pre-charging electrical continuity exist. Simultaneous fuelling and electrical charging of a PHEV may further be inhibited by detecting whether a fuel door of the vehicle is in a fueling-permitting condition and, if the fuel door is in the fueling-permitting condition, preventing an on-board charger engaged with a charging plug from receiving charging current from the charging plug.

### TECHNICAL FIELD

The present invention relates to plug-in hybrid electric vehicles and to a method and apparatus for improving operating safety during recharging and refueling of such vehicles.

### BACKGROUND

A plug-in electric hybrid vehicle (PHEV) has both a battery-powered electric motor and a fuel burning engine, both of which may provide motive power for the vehicle. Further, the battery of a PHEV may be recharged by an off-board source of electricity. This is normally accomplished by connecting the power supply to a charging port on the vehicle when the vehicle is parked. Since PHEVs also have a fueling port through which the fuel tank is refilled, there is a possibility that a vehicle operator may ignore recommended safe operating procedures and attempt to perform both refueling and recharging simultaneously.

Various systems and methods have been proposed which require that both the refueling port and the charging port on the vehicle be fitted with a lockable door, and that the open/closed condition of both these doors be monitored and utilized by a controller on board the vehicle to prevent both doors from opening at the same time.

### SUMMARY

In a disclosed embodiment, apparatus for preventing electrical charging of a vehicle while it is being fuelled comprises an on-board charger connectable with a charging plug to receive charging current therefrom, a door controlling access to a fueling port, and a control module operative to detect that the charger and the plug are in pre-charging electrical connection, detect a fueling-permitting condition of the door, and prevent the charger from receiving charging current if the door is in the fueling-permitting condition.

In a disclosed embodiment, apparatus for preventing electrical charging of a vehicle while it is being fuelled comprises an on-board charger connectable with a charging plug to receive charging current therefrom, a door controlling access to a fueling port, and a control module operative to detect that the charger and the plug are in pre-charging electrical connection, detect a fueling-permitting condition of the door, and prevent the charger from receiving charging current if the door is in the fueling-permitting condition.

For a vehicle having a fuel door locking system, the fueling-permitting condition may comprise unlocking of the door. In this embodiment, the controller may be further operable prevent fueling while electrical charging is in progress by preventing the fuel door locking system from unlocking the door if the pre-charging electrical connection exists.

In another disclosed embodiment, apparatus for preventing fueling of a vehicle while electrical charging is in progress comprises an on-board charger connectable with a charging plug, a door controlling access to a fueling port, a lock alternatively locking and unlocking the door, and a control module operable to prevent the lock from unlocking the door upon detection of a signal indicating electrical continuity between the charger and the charging plug. To prevent electrical charging while fueling is in progress, the control module may be further operative to receive a door locked/unlocked signal and prevent the on-board charger from receiving charging current if the door is unlocked.

In another disclosed embodiment, a method for impeding simultaneous electrical charging and fueling of a vehicle comprises detecting pre-charging electrical continuity between an on-board charger of the vehicle and a charging plug engaging the charger, and impeding opening of a door controlling access to a fueling port if the pre-charging electrical continuity exist.

In another disclosed embodiment, a method for impeding simultaneous electrical charging and fueling of a vehicle comprises detecting whether a fuel door of the vehicle is in a fueling-permitting condition and, if the fuel door is in the fueling-permitting condition, preventing an on-board charger engaged with a charging plug from receiving charging current from the charging plug.

### BRIEF DESCRIPTION OF THE DRAWINGS

FIG. 1 is a schematic overall view of PHEV with both an electrical power plug and a refueling hose attached thereto;

FIG. 2 is a simplified block diagram of a portion of a PHEV electrical system;

FIG. 3 is a process flow chart of a first method in accordance with a disposed embodiment; and

FIG. 4 is a second flow chart depicting a method in accordance with another embodiment disposed herein.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

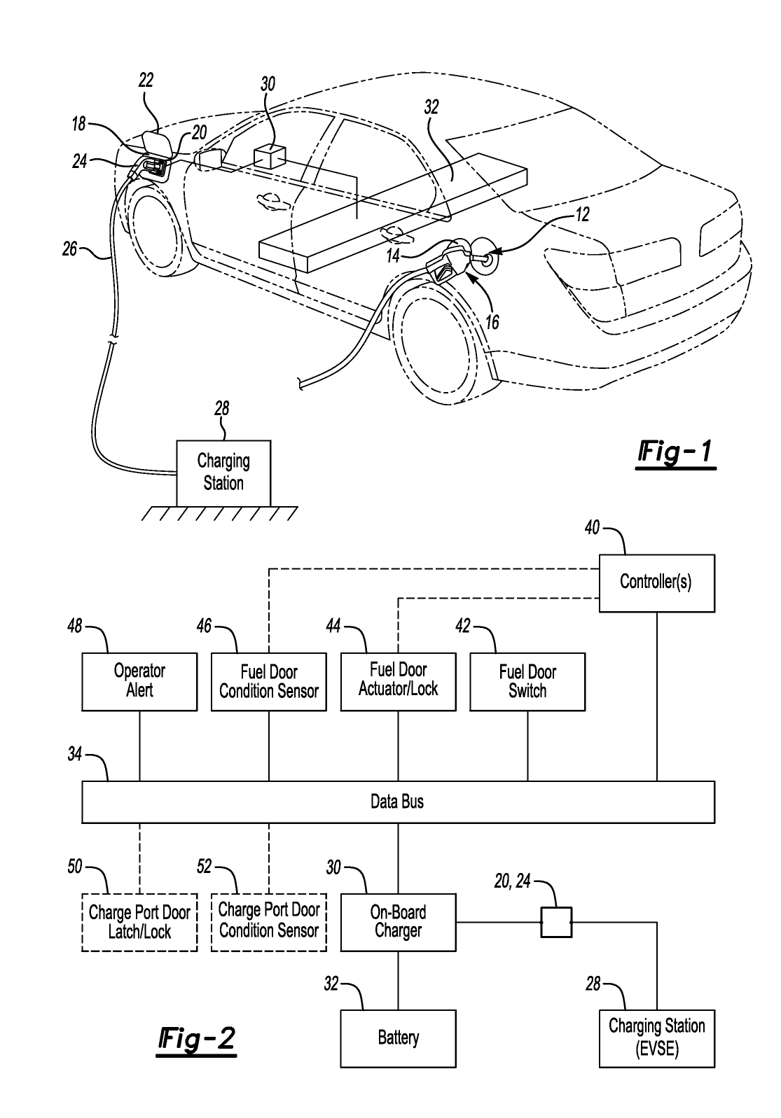

FIG. 1 generically depicts a plug-in hybrid electric vehicle (PHEV) 10 in phantom lines with parts of the vehicle that are pertinent to describing the present invention depicted in solid lines. PHEV 10 has a refueling port 12 located on an exterior body panel of the vehicle. The refueling port 12 is fitted with a fuel door 14 that is moveable between an open condition (shown) which allows access to a fuel fill pipe and a closed condition (not shown) that blocks access to the fill pipe. A fueling nozzle 16 is shown inserted into the refueling port 12 as it would be when refueling of the vehicle is underway.

PHEV 10 further has a charging port 18 located on an exterior body panel of the vehicle and a charging port door 22 that is moveable between an open condition (shown) and a closed condition (not shown). A charging plug 24 is connected via a charge cord 26 with a charging station 28. Charging station may be of the type generically known in the industry as electric vehicle supply equipment (EVSE) which complies with industry standards to condition electrical energy from an electricity source as required to charge a vehicle's batteries. As is well known in the art, when the EVSE and PHEV 10 are connected with one another, the EVSE monitors and/or communicates with the vehicle's electrical system to ensure that the charging electricity supplied to the vehicle is of the appropriate type (voltage, amperage, etc.).

An on-board charger (OBC) 30 and battery 32 are schematically indicated as being in electrical connection with receptacle 20. Battery 32, as is well known in the electric vehicle field, powers an electric motor (not shown) that provides motive power for the vehicle and/or other vehicle electrical systems. OBC 30 is an electrical component that monitors and manages the charging and state of battery 32, as is well known in the art.

FIG. 2 shows pertinent portions of the electric system of a PHEV in schematic block diagram form. The components are shown and interconnected by a data bus 34, as is the case with most motor vehicle system architectures today. Direct connections between some or all of the components are also possible, and are within the scope of the present invention.

Controller 40 may be a microprocessor-based controller having a central processing unit, internal memory such as RAM and/or ROM), and associated inputs and outputs communicating across data bus 34. Controller 40 may be a portion of a central vehicle main control unit or a stand-alone unit, such as a powertrain control module (PCM), as is known in the art. Controller 40 may include various processing units which may be incorporated as separate devices or as an integral part of the controller.

A fuel door switch 42 may be manually and/or voice activated switch that is used by the vehicle operator to trigger fuel door actuator/lock 44 when fueling of the vehicle is desired. Alternatively or in addition, a fuel door condition sensor 46 may be provided which monitors the open/closed condition of fuel door 14 and reports this condition to controller 40. An operator alert 48, such as an instrument panel-mounted light and/or an audible sound may also be provided for reasons that will be further explained below.

A charge port door latch/lock 50 and/or charge port door condition sensor 52 may also be provided to control and/or monitor the condition of the charging port door 22.

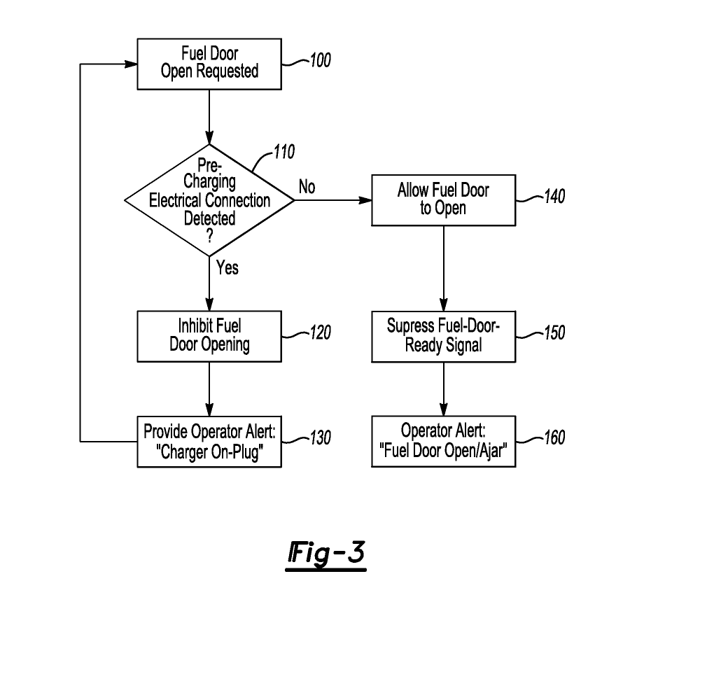

FIG. 3 illustrates a method of inhibiting fueling of the vehicle while electrical charging is in progress. At block 100, a request or command to open the fuel door is made. This may, for example, comprise an operator activating a switch in anticipation of fueling the vehicle. The switch activation may directly or indirectly result in generation of an electrical signal that is communicated to a controller (such as controller 40 in FIG. 2).

At block 110, the controller detects or determines whether or not a pre-charging electrical connection has been established between an on-board charger and an off-board charging station. The pre-charging electrical connection requires that the charging plug 24 and charging receptacle 20 are engaged with one another to achieve proper electrical continuity such that charging current may flow from the charging station to the on-board battery when charging commences.

When the charging station complies with current industry standards for an EVSE, pre-charging electrical connection is established by an exchange of electrical signals between the on-board charger and the EVSE allowing one or both of the components to confirm that compatible charging conditions exist. The condition in which the on-board charger is properly connected with the EVSE so that charging of the vehicle battery may begin is commonly referred to as the “on-plug” condition.

Once the on-plug condition is confirmed, current flow to charge the battery may still not occur until other vehicle systems are in respective conditions appropriate for charging. For example, charging may not be enabled until the controller and/or on-board charger receive signals indicating that a vehicle transmission is in a PARK mode.

When the charger and/or EVSE have confirmed that proper electrical connection has been established (block 110, “YES”), this is relayed to the controller and the method progresses to block 120 where the controller prevents or inhibits opening of the fuel door. This may be achieved by preventing the fuel door open request generated at block 100 from being relayed to the fuel door actuator/lock 44. This “door-open inhibit” condition is preferably accompanied by an alert provided to the vehicle operator notifying him/her that the on-board charger 30 is in electrical connection with a charging station or EVSE.

If the pre-charging electrical connection between the on-board charger and the charging station is not detected (block 110, “NO”), the method progresses to block 140 and the fuel door is allowed to open. This may be achieved by the controller relaying the fuel door open command/signal to a fuel door actuator/lock mechanism.

When the fuel door has been allowed to unlock and/or open, the on-board charger may be prevented from transitioning to a “ready” condition” in which charging may commence (block 150). This step may comprise suppressing a “fuel-door-ready” signal from being sent to the charger from a fuel door actuator and/or lock or from some other controller. Accompanying step 150, an operator alert may be provided to notify the driver that the fuel door is opened (block 160) and so no battery charging may be conducted.

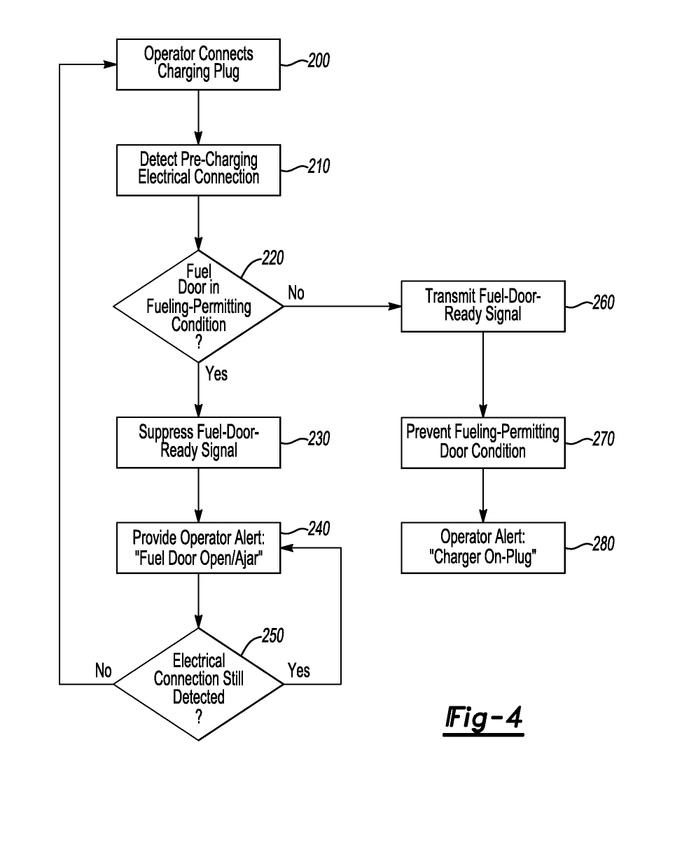

Referring now to FIG. 4, a method for preventing charging of a vehicle battery while fueling is in progress is shown in the form of a flow chart. At block 200, a vehicle operator connects a charging plug with a vehicle charging port. At block 210, an on-board charger or other controller device checks for pre-charging electrical connection between the on-board charger and a charging station/EVSE. At block 220, a check is made as to whether a fuel door is in a fueling-permitting condition such as is necessary to allow fueling to take place.

The conditions that define or determine the fueling-permitting condition may vary depending upon the nature of the fuel door used on a vehicle. For example, in the case of a vehicle having a lockable fuel door, the fueling-permitting condition would exist when door is unlocked and therefore able to be opened. Depending upon the nature of the door locking system, a locking actuator and/or a door sensor may supply the required information to determine whether the fueling-permitting condition exists. In the case of a fuel door that does not have a locking feature, a fuel door position sensor may provide the required information by detecting whether the door is fully closed or is ajar.

If the fuel door is a fueling-permitting condition (block 220, “YES”), the method progresses to block 230 and a “fuel door ready” signal to the on-board charger is suppressed or prevented. The “fuel door ready” signal indicates that the door is not in a fueling-permitting condition, and may be one of a plurality of “ready” signals that are required from other vehicle systems. The on-board charger does not permit charging to begin until all appropriate/required ready signals have been received. For example, a “transmission ready” signal may be required to indicate that the vehicle transmission is in state consistent with safe and effective battery charging. In any event, in the absence of the “fuel door ready” signal, the on-board charger cannot transition to a charging state.

At block 240, an operator alert may be provided to notify the operator that the fuel door is in the fueling-permitting condition (open or ajar, for example) and therefore charging cannot begin.

If at block 220, the fuel door is a condition that is inconsistent with a fueling operation, (locked and/or closed, for example), the method progresses to block 260 where the “fuel door ready” signal is supplied to the on-board charger. As previously discussed, the fuel door ready signal may be one of a plurality of “ready” signals required before charging can begin. At block 270, properly equipped will take necessary actions to prevent the fuel door from achieving a fueling-permitted condition. In a vehicle having a fuel door locking system, for example, the locking system is inhibited from being opened/unlocked while charging is in progress. In combination with this, an operator alert may be provided to notify the operator that the on-board charger is in the on-plug condition (block 280) and/or that the fuel door cannot be opened and/or unlocked.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. Apparatus for a vehicle comprising:
an on-board charger connectable with a charging plug to receive charging current therefrom;
a door controlling access to a fueling port; and
a control module operative to prevent the on-board charger from receiving charging current in response to the door being in a fueling-permitting condition when the charger and the plug are in pre-charging electrical connection.

2. The apparatus of claim 1 wherein the pre-charging electrical connection is detected by an exchange of signals between the charger and a charging station supplying electric current to the plug.

3. The apparatus of claim 1 further comprising a device providing an alert to an operator when the control module prevents the on-board charger from receiving the charging current.

4. The apparatus of claim 1 further comprising a door condition sensor, wherein the fueling-permitting condition corresponds to a door open condition.

5. The apparatus of claim 1 wherein the control module prevents the on-board charger from receiving charging current by suppressing a fuel-door-ready signal being sent to the charger.

6. The apparatus of claim 1 further comprising a door locking system, wherein the fueling-permitting condition corresponds to the door locking system indicating the door is unlocked.

7. The apparatus of claim 6 wherein the control module is further operative to:
prevent the door locking system from unlocking the door if the pre-charging electrical connection exists.

8. The apparatus of claim 7 further comprising a device providing an alert to an operator when the door is prevented from being unlocked.

9. Apparatus for a vehicle comprising:
an on-board charger connectable with a charging plug;
a door controlling access to a fueling port;
a lock selectively locking and unlocking the door; and
a control module preventing the lock from unlocking the door upon detection of a signal indicating electrical continuity between the charger and the charging plug.

10. The apparatus of claim 9 further comprising a device activated by the control module to provide an alert to an operator when the lock is prevented from unlocking the door.

11. The apparatus of claim 9 wherein the control module is further operative to:
receive a door locked/unlocked signal and prevent the on-board charger from receiving charging current if the door is unlocked.

12. The apparatus of claim 11 wherein the control module prevents the charger from receiving charging current by suppressing a fuel-door-ready signal being sent to the charger.

13. The apparatus of claim 11 further comprising a device activated by the control module to alert an operator when receipt of the charging current is prevented due to the door being unlocked.

14. A method for impeding simultaneous electrical charging and fueling of a vehicle comprising:
detecting pre-charging electrical continuity between an on-board charger of the vehicle and a charging plug engaging the charger; and
impeding opening of a door controlling access to a fueling port if the pre-charging electrical continuity exists.

15. The method of claim 14 wherein impeding opening of the door comprises suppressing an unlock signal sent to a door lock.

16. The method of claim 15 wherein the door lock is part of a central vehicle locking system.

17. The method of claim 14 wherein detecting the pre-charging electrical continuity comprises sending an electrical signal at least one way between the charger and the plug.

18. The method of claim 14 further comprising:
providing an operator alert if opening of the door is impeded due to detection of pre-charging electrical continuity.

19. The method of claim 14 further comprising:
preventing the on-board charger from receiving charging current from the charging plug if the door is in a fueling-permitting condition.

20. The method of claim 19 further comprising:
providing an operator alert if receipt of charging current by the on-board charger is prevented due to the door being in the fueling-permitting condition.

21. The method of claim 14 wherein opening of the door is impeded by preventing a command from an operator to unlock the door from being carried out.

22. A method for impeding simultaneous electrical charging and fueling of a vehicle comprising:
detecting whether a fuel door of the vehicle is in a fueling-permitting condition; and
if the fuel door is in the fueling-permitting condition, preventing an on-board charger engaged with a charging plug from receiving charging current from the charging plug.

23. The method of claim 22 further comprising:
providing an operator alert if receipt of charging current by the on-board charger is prevented.

24. The method of claim 22 further comprising:
impeding unlatching of the door if electrical continuity exists between the on-board charger of the vehicle and the charging plug.

25. The method of claim 22 further comprising:
providing an operator alert if opening of the door is prevented.

26. A method for operating a vehicle comprising:
detecting whether electrical continuity exists between an on-board charger and a charging plug engaging the charger;
detecting whether a fuel door of the vehicle is openable;
if continuity is detected, preventing opening of the fuel door; and
if the fuel door is openable, preventing the on-board charger from receiving charging current from the charging plug.
